(19) United States
(12) Patent Application Publication
(10) Pub. No.: US 2017/0223990 A1
(43) Pub. Date: Aug. 10, 2017

(54) FOOD PRESERVATION WITH FOLATES

(71) Applicant: UNIVERSITY OF CALCUTTA, Kolkata (IN)

(72) Inventor: Nilanjan DEB, Kolkata (IN)

(73) Assignee: UNIVERSITY OF CALCUTTA, Kolkata (IN)

(21) Appl. No.: 15/424,662

(22) Filed: Feb. 3, 2017

(30) Foreign Application Priority Data
Feb. 4, 2016 (IN) 201631004033

(51) Int. Cl. A23L 3/3544; B65D 81/28; B65D 43/02

(52) U.S. Cl. CPC A23L 3/3544; B65D 43/02; B65D 81/28; A23V 2002/00

(57) ABSTRACT

A method of preserving a harvested cultivated food can include applying a preservative composition onto a cultivated food. The preservative composition can include a folate substance or hydrogel having the folate substance in a carrier. The carrier and/or hydrogel may facilitate application of the folate to the cultivated food and may contribute to the improvement of preservation of the cultivated food post-harvest. A container can be configured for protecting harvested cultivated food by having a chamber with a preservative composition located in the container. A substrate can include a preservative composition located on the substrate, which can be applied to a cultivated food to increase preservation.

### RELATED APPLICATION

This application claims priority of Indian Provisional Application No. 201631004033, filed Feb. 4, 2016 and entitled “Food Preservation with Folates” the disclosure of which is incorporated by reference in its entirety.

### FIELD OF TECHNOLOGY

The field of the technology relates to the use of folates (e.g., folic acid and/or folate salts, or derivatives) with or without a hydrogel carrier in food preservation systems and methods.

### BACKGROUND

Even though harvested food preservation techniques have been researched and utilized throughout the duration of humankind, harvested food continues to become spoiled and inedible. Food spoilage may occur at any time during post-harvest handling. The harvested food may become inedible due to over-ripening that may cause bad odors, color change, loss of texture, loss of crispness, loss of flavor, and overall appearance of inedibility. Thus, improvements in food preservation, storage, and shelf life continues to be needed in developing and developed countries regardless of geographical location.

### OBJECT

An object of the technology described herein is to improve the shelf life and preservation of harvested food with systems and methods that utilize folates (e.g., folic acid and/or folate salts, or derivatives) with or without a hydrogel carrier to protect the harvested food. The foregoing object is illustrative only and is not intended to be in any way limiting.

### STATEMENT

The technology includes food preservation systems and methods that utilize folates (e.g., folic acid and/or folate salts, or derivatives) with or without a hydrogel carrier. The food preservation systems can include preservative compositions having folates (e.g., folic acid and/or folate salts, or derivatives) with or without a hydrogel carrier, containers to contain harvested food having the preservative compositions, and packages having an interior coated with a preservative composition and containing the harvested food therein. The methods can utilize the food preservation systems for enhancing preservation of harvested food to improve food storage and shelf life. The foregoing statement is illustrative only and is not intended to be in any way limiting.

### SUMMARY

In one embodiment, a method of preserving a harvested cultivated food can include applying a preservative composition onto a cultivated food. The preservative composition can include a folate (e.g., folic acid and/or folate salts, or derivatives). The folate can be associated with a hydrogel carrier, where such association can be by covalent coupling, ionic association, encapsulation, non-covalent associate, Van Der Waals forces, or other forces. The hydrogel carrier may facilitate application of folate to the cultivated food and may contribute to the improvement of preservation of the cultivated food post-harvest. The cultivated food can be harvested before, during, or after application of the preservative composition. This can include application of the preservative composition while the cultivated food is still growing on a plant, as the cultivated food is being harvested, or after the cultivated food has been harvested. In some instances, application of the preservative composition at an early stage can prolong the edibility of the food due to improved preservation and shelf life.

In one embodiment, a container can be configured for protecting harvested cultivated food. The container can include a container body defining a chamber and having a removable lid. A preservative composition can be located in the container. The preservative composition can include a folate, where the folate can be associated with a hydrogel carrier. In one aspect, the preservative composition is a liquid or a hydrogel, where the liquid can be processed into a hydrogel.

In one embodiment, a substrate can be used for protecting harvested cultivated food. The substrate can include a substrate body. A preservative composition can be located on the substrate. The preservative composition can be formulated in accordance with any embodiment described herein. In one aspect, the substrate is a flexible polymeric substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an embodiment of a food preservation system.

FIG. 2 illustrates another embodiment of a food preservation system.

FIG. 3 illustrates an embodiment of a food preservation package.

FIG. 4 illustrates another embodiment of a food preservation package.

FIG. 5 illustrates an embodiment of a food preservation substrate.

FIG. 6 illustrates another embodiment of a food preservation substrate.

FIG. 7 illustrates an embodiment of food preserved with a food preservation composition.

FIG. 8 illustrates an embodiment of food packaged in a food preservation package.

FIG. 9 illustrates an embodiment of food in a food preservation composition.

FIG. 10 illustrates an embodiment of manufacturing a food preservation substrate.

FIG. 11 illustrates another embodiment of manufacturing a food preservation substrate.

FIG. 12 illustrates an embodiment of a method of applying a preservation composition to a food.

The elements in the figures are arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the technology described herein relates to systems and methods for preservation of cultivated foods, such as fruit, vegetable, nuts, seeds, or the like. The systems and methods may inhibit biological functions that ripen or over-ripen or degrade the cultivated food after harvesting to provide an extended storage and shelf life. The systems and methods may be utilized before, during or after harvesting the cultivated food, and may be utilized during post-harvest packaging. As such, reference herein to a “cultivated food” is meant to describe a fruit, vegetable, nut, or seed, or any other edible plant-based food that is grown and cultivated. A “harvested food” or “harvested cultivated food” refers to a cultivated food that has been harvested. Additionally, reference generically to “food” may be a cultivated food before or after harvesting. Accordingly, the systems and methods may also be used for enhancing the preservation of any cultivated food by the mechanisms described herein, without limitation. Any cultivated food that may need preservation can be preserved with the systems and methods that inhibit biological processes that cause ripening or degradation post harvesting.

The systems and methods described herein can be used for preservation of post-harvest cultivated food in order to increase storage and shelf life, and allow for consumption of cultivated food long after harvesting. The systems and methods may be employed in any geographic area, and may be utilized at any time before, during, and/or after harvesting of the cultivated food. However, it may be beneficial to implement the systems and methods soon after harvesting, which may include such systems being utilized in agricultural areas, such as farms, or in general food storage or shipping plants or operations. The systems and methods may be beneficial in areas that lack standard industrialization and processing of harvested foods, such as in developing countries, and may also be utilized in industrialized regions and implemented in the processing of harvested foods on large scales.

The systems and methods may also be utilized in stores to preserve the harvested foods, and may be included in packaging having the harvested foods. As such, the packaging that utilizes the systems and methods may retain the harvested food in good edible condition after purchase and prior to consumption, and during any transportation or storage thereof. The systems and methods may also be used in homes for increased harvested food preservation and shelf life. The systems and methods may also be adapted to be used for harvested food transportation in instances without traditional refrigeration. An example of a use can include hiking or backpacking, where the systems and methods can preserve the harvested food during such activities for longer preservation without refrigeration. On the other hand, the systems and methods may be practiced in harvested food packaging in refrigerators and possibly in freezers when such cold temperatures do not degrade the harvested food (e.g., seeds or nuts). The harvested food packaging utilizing the systems and methods may be pressurized or at normal (e.g., ambient) pressures or in a vacuum. Accordingly, the systems and methods may be practiced at a range of temperatures and pressures. Thus, the systems and methods can be utilized anywhere for enhanced preservation, storage and shelf life extension of harvested foods.

The systems for preserving foods include the use of a preservative composition that includes a folate (e.g., folic acid and/or folate salts, or derivatives) with or without a hydrogel carrier. The folates and hydrogel carriers are described herein.

The folate substance can be any folate or folate derivative. In one aspect, the folate substance is any folate substance selected from the group consisting of folic acid, folate, folate ion, folate salt, tetrahydrofolic acid, tetrahydrofolate, tetrahydrofolate ion, tetrahydrofolate salt, methyltetrahydrofolic acid, methyltetrahydrofolate, methyltetrahydrofolate ion, methyltetrahydrofolate salt, levomefolic acid, levomefolate, levomefolate ion, levomefolate salt, degradation product thereof, or combination thereof. In one aspect, the degradation product of the folate substance includes a pterin, para-amino benzoic acid, benzoic acid, para-amino benzoyl glutamic acid, para-amino benzoyl glutamate, ions thereof, salts thereof, or combinations thereof. In one aspect, the folate is folic acid or salt thereof.

The hydrogel carrier can be any substance that is a hydrogel, a hydrogel precursor, or liquid having the hydrogel dissolved therein. In one aspect, the hydrogel carrier is formed from a crosslinked polymer. The polymer can be selected from the group consisting of polyethylene glycol, hydroxyethyl cellulose, hydroxypropyl cellulose, ethyl cellulose, methylcellulose, ethylmethyl cellulose, carboxymethyl cellulose, hydroxypropyl methyl cellulose, cellulose acetate, cellulose triacetate, cellulose propionate, cellulose acetate butyrate, and combinations thereof. In one aspect, the hydrogel carrier includes hydroxypropyl cellulose, hydroxypropyl methyl cellulose, carboxymethyl cellulose, or methyl cellulose. Other similar polymers may also be used that may provide a hydrogel carrier. In one aspect, the hydrogel carrier is edible.

In one embodiment, the preservative composition may include a gelatin. The gelatin can be mixture of peptides and proteins produced by partial hydrolysis of collagen, and may include collagen. The gelatin can be crosslinked with glutaraldehyde. The gelatin and cellulose can be crosslinked independently or together. The gelatin and cellulose can be used to prepare the hydrogel carrier.

In one aspect, the preservative composition includes the folate substance covalently conjugated with the hydrogel carrier. For example, the hydrogel carrier can be coupled through a carboxyl group of the folate substance; however, it may be possible to link either or both of the carboxyl groups of folate substance with the hydrogel.

In one aspect, the folate substance can be entrapped within the hydrogel carrier. That is, the hydrogel carrier can include the folate substance therein without covalent coupling. The folate substance may also be located at the surface of the hydrogel carrier.

The preservative composition may be provided in various forms. In one example, the preservative composition can be provided as the folate substance and hydrogel carrier in an aqueous solution. The preservative composition may also be a gel. In another example, the preservative composition can be dried to remove the water to leave dried folate and cross-linked polymer (e.g., hydrogel), such as in the form of a film or coating on the harvested food. In another example, the preservative composition can be milled into a powder. In another example, the preservative composition can be attached to a substrate (e.g., beads, wafers, blocks, ribbons, strands, sheets, films, etc.), such as optionally with an adhesive (e.g., bioadhesive, food-grade adhesive, etc.) when the preservative composition does not stick to the substrate without adhesive. In another example, the preservative composition can be loaded on and/or in or formed into a polymeric carrier, such as polymeric beads, ribbons, strands, films, sheets or other substrates, where the hydrogel carrier can optionally be porous when embedded therein. In another example, the preservative composition can be a hydrogel that is applied to the harvested food. In another example, the preservative composition can be loaded into a porous member, such as a porous substrate (e.g., polymeric substrate). In another example, the preservative composition may be loaded onto a semipermeable member (e.g., polydimethylsiloxane (PDMS), alumina, titania, zirconia, silanized alumina, etc.), such as an oxygen permeable membrane, whether hydrophilic or hydrophobic. In another example, the preservative composition can be loaded onto an oxygen porous membrane, matrix, or film. In these examples, the preservative composition may include the folate without the hydrogel. Alternatively, the preservative composition may include the folate with the hydrogel carrier that is formulated or otherwise configured in accordance with these examples.

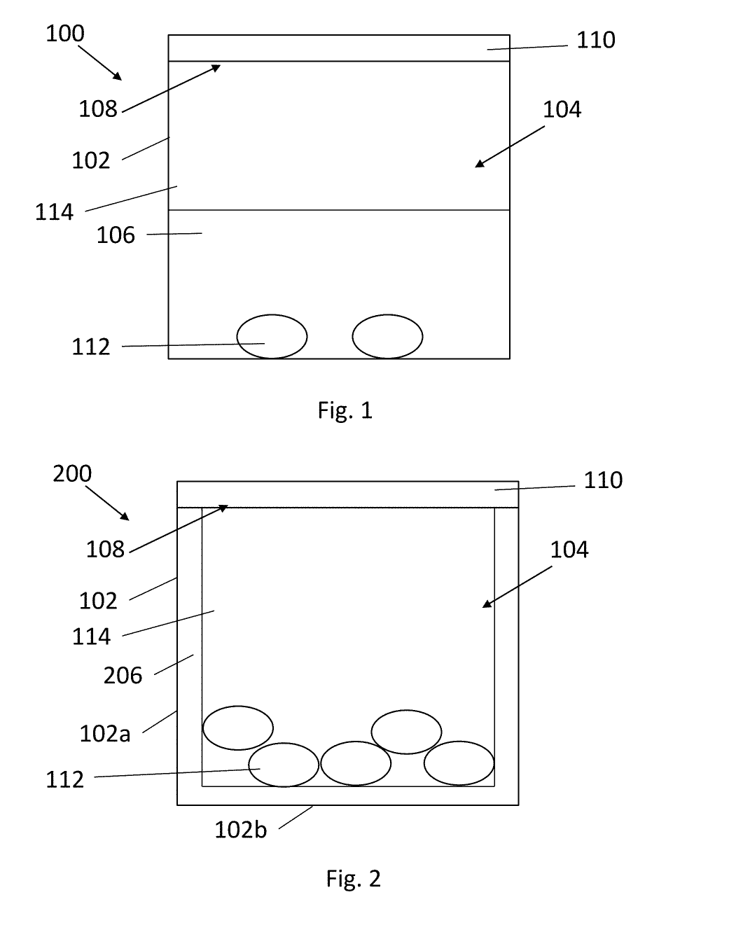

FIG. 1 illustrates an embodiment of a food preservation system 100. The food preservation system 100 can include a container 102 that has an internal chamber 104 having a preservative composition 106 therein. The container can have an opening 108 that can be closed and sealed with a lid 110. The lid 110 can form an airtight coupling with the container 102. The lid 110 can be fit onto the container 102 in any way, such as threading, snap fit, friction fit, or the like. While not shown, a sealing member (e.g., O-ring, gasket, etc.) may be used to enhance the sealing of the lid 110 to the container 102 to form an airtight system in the internal chamber 104. As shown, food 112 is placed in the preservative composition 106 in the internal chamber 104. Here, the preservative composition 106 is flowable, such as a liquid (e.g., aqueous composition) or flowable gel (e.g., thickened aqueous composition) or set gel so that the food 112 can be immersed into the preservative composition 106 and extracted therefrom so as to retain some of the preservative composition 106 on surfaces of the food 112. In one example, the preservative composition 106 can be dried and powdered so as to be flowable to also allow immersion of food 112 therein and removal therefrom. A headspace 114 can optionally be included in the container 102 so that the preservative composition 106 has room to be jostled, stirred, or mixed for improving contact with the food 112 and preservative composition 106. For example, the food 112 can be filled in the internal chamber 104 above the level of the preservative composition 106, and the container 102 can be shaken so that the preservative composition 106 can contact all of the food 112. Alternatively, the entirety of the internal chamber 104 can be filled with the preservative composition 106. The container 102 may be used for applying the preservative composition 106 to the food, such that either the preservative composition 106 or food 112 is removed from the container 102 after partially or fully coating the food 112 with the preservative composition 106. The container 102 can be reused for coating additional foods with the preservative composition 106, or the container 102 can have the preservative composition 106 removed and the food 112 can be sealed in the container 102 with the lid 110.

FIG. 2 illustrates another embodiment of a food preservation system 200 that includes many of the features of the system 100 of FIG. 1. However, instead of the preservative composition 206 being flowable, it is adherent to the internal surfaces of walls of the internal chamber 104. Accordingly, the preservative composition 206 can be a thickened gel, paste, coating, film, or the like that sticks to the walls of the container, such as side walls 102a and/or bottom wall 102b. The internal chamber 104 can include a headspace 114 that can be filed with the food 112. The food 112 can receive the preservative composition 206 by contact therewith. As such, the headspace 114 allows for the container 102 to be shaken so that the food 112 contacts and receives the preservative composition 206.

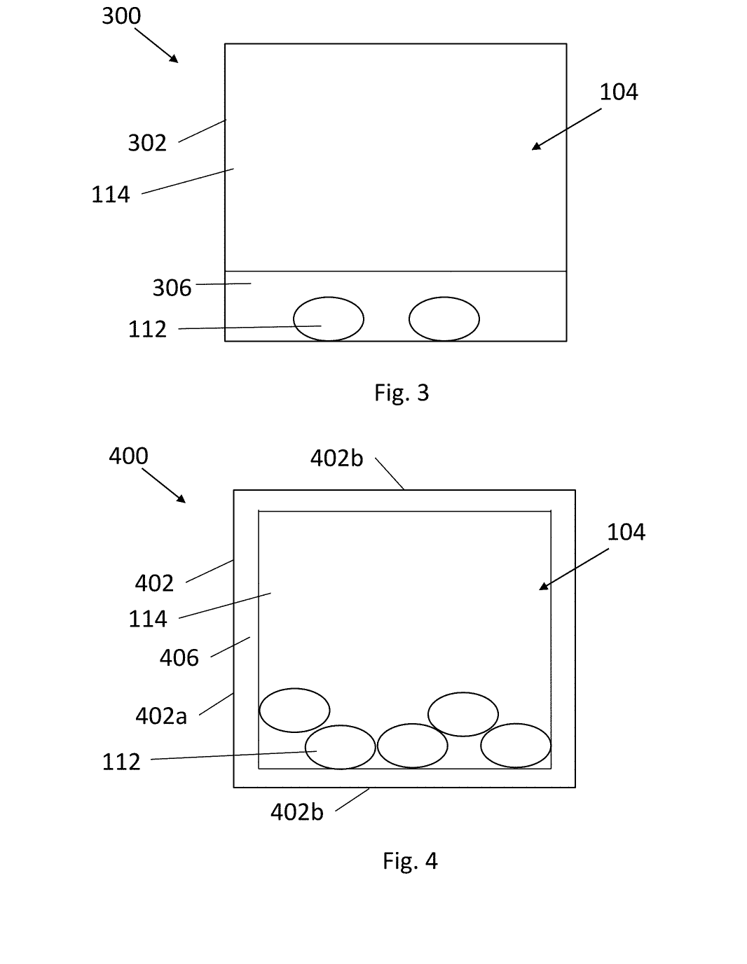

FIG. 3 illustrates an embodiment of a food preservation package 300 that includes many of the features of the system 100 of FIG. 1. However, the container 302 is configured as a package that is completely sealed and omits the opening 108 and lid 110. Also, the container 302 can be flexible, such as a bag. The preservative composition 306 can be flowable as described in connection with FIG. 1. The package configuration of the container 302 can allow for small quantities of the preservative composition 306 to be retained in the internal chamber 104 with the food 112 after being sealed. Accordingly, the preservative composition 306 can be retained with the food 112 during shipping and storage.

FIG. 4 illustrates another embodiment of a food preservation package 400 that includes many of the features of the system 300 of FIG. 3. However, the container 402 (e.g., configured as a flexible package) has the internal walls of the internal chamber 104 coated with the preservative composition 406 similar to FIG. 2. This can include the internal chamber 104 being coated on and between side walls 402a and between end walls 402b. This allows the food 112 to be sealed in the container 402 with the preservative composition 406 for shipping and storage.

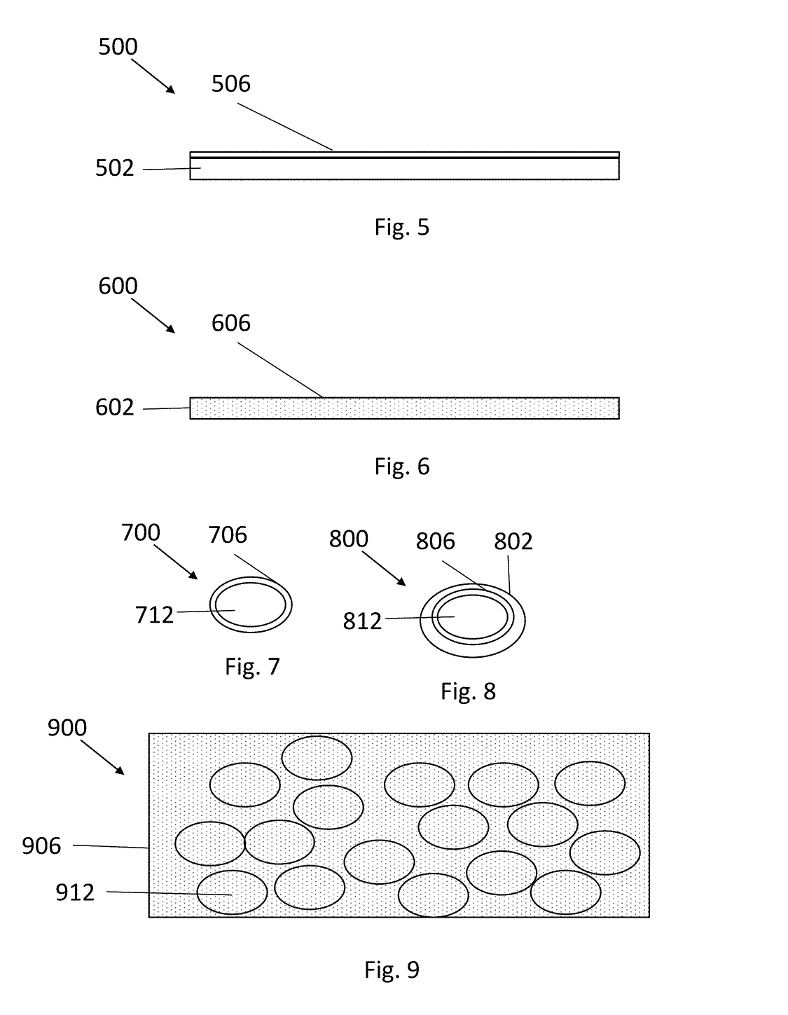

FIG. 5 illustrates an embodiment of a food preservation substrate 500 that includes a substrate 502 having the preservative composition 506 thereon.

FIG. 6 illustrates another embodiment of a food preservation substrate 600 that includes a substrate 602 having the preservative composition 606 therein.

FIG. 7 shows an embodiment of a preserved food 700 having the food 712 coated with the preservative composition 706.

FIG. 8 shows an embodiment of a packaged preserved food 800 having the food 812 fully or partially encapsulated (e.g., airtight or not airtight) with a package 802 having the preservative composition 806 therein such that the food 812 is covered (e.g., partially or fully) with the preservative composition 806.

FIG. 9 shows an embodiment of a preserved food 900 having the food 912 contained in preservative composition 906 such that the food 912 is covered with the preservative composition 906. The preservative composition 906 can be in any form ranging from liquids, gels, hydrogels, pastes, powder, degradable polymer, or the like.

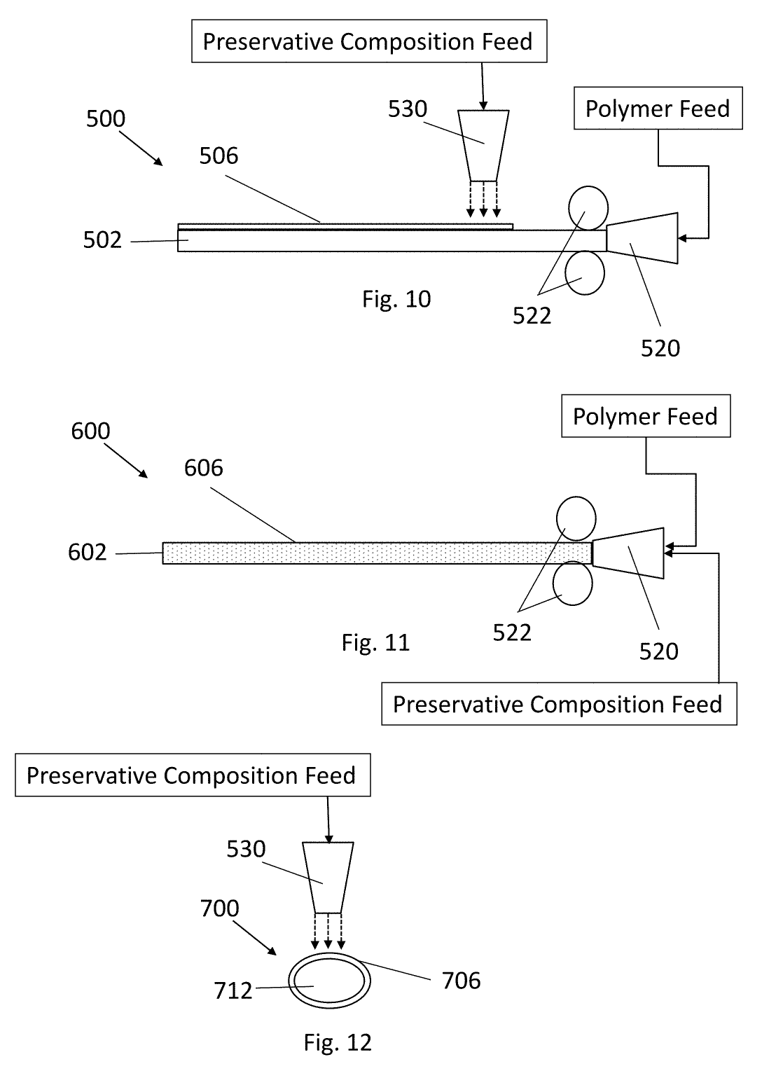

FIG. 10 shows a method of making the food preservation substrate 500 of FIG. 5. As shown, the substrate 502 is formed, such as for example by calendaring a pre-substrate composition (e.g., polymer feed) that is extruded by a die 520. The calendaring is performed by rollers 522. After forming the substrate 502, a sprayer 530 can spray the preservative composition 506 onto the substrate 502. While only one surface is shown to be coated with the preservative composition 506, all surfaces of the substrate 502 may be coated.

FIG. 11 shows a method of making the food preservation substrate 600 of FIG. 6. As shown, the substrate 602 having the preservative composition 606 therein is formed, such as for example by calendaring a mixture (e.g., polymer feed and preservative composition feed) that is extruded by a die 520. The calendaring is performed by rollers 522. Here, the substrate 602 may be the hydrogel having the folate.

FIG. 12 shows a method of making the preserved food 700 of FIG. 7. As shown, a sprayer 530 can spray the preservative composition 706 onto the food 712.

In one embodiment, a container can be configured for protecting harvested cultivated food. As such, the container can include a removable lid that allows the harvested cultivated food to be introduced therein and removed therefrom. A preservative composition can also be in the container. The preservative composition can be configured as described herein with the folate substance with or without a hydrogel carrier. The preservative composition can be formulated as described herein. In an example, the preservative composition is an aqueous liquid or gel; however, other forms of the preservative composition can be used.

In one embodiment, a substrate can be configured for protecting harvested cultivated food. The substrate can include a preservative composition on one or more surfaces of the substrate. The substrate may be the preservative composition when sufficiently gelatinous. The preservative composition can be formulated as described herein. In one non-limiting example, the substrate is a flexible polymeric substrate (e.g., food wrapper, such as polypropylene or polyethylene); however, other forms of the substrate can be used.

In one embodiment, a method of preserving a harvested cultivated food can be implemented, such as with the preservative compositions and systems described herein. The method can include applying a preservative composition onto a cultivated food. The preservative composition can be formulated as described herein. The method can also include harvesting the cultivated food, or obtaining the harvested cultivated food post-harvest. The application of the preservative composition to the cultivated food can be performed prior to harvesting, during harvesting, or after harvesting the cultivated food.

The preservative composition can be provided in various forms. In one aspect, the preservative composition includes the folate substance covalently conjugated to the hydrogel carrier. In another aspect, the folate substance is ionically associated with an ionic water soluble substance. In another aspect, the folate substance and hydrogel carrier can be associated by hydrophobic forces, Van Der Waals, or other forces. The hydrogel carrier may be formed from crosslinking linear polymers, where one or more of the polymers is coupled to the folate substance. The hydrogel carrier may also be a matrix that contains the folate substance, such as by covalent coupling or other association or encapsulation.

The method of preserving the harvested cultivated food can be used for further extending the duration of edibility of the food. The preservation can inhibit biological processes that cause the food to ripen and then degrade after harvesting. As such, the method can include applying a sufficient amount of the preservative composition to improve the storability and shelf life after harvesting. Such improvement may be obtained by inhibiting one or more of the following: inhibit ripening of the cultivated food after harvesting the cultivated food; inhibit degradation of the cultivated food after harvesting the cultivated food; inhibit cell wall degradation in the cultivated food after harvesting the cultivated food; inhibit cellulose or hemicellulose degradation in the cultivated food after harvesting the cultivated food; inhibit formation of acetylene in the cultivated food after harvesting the cultivated food; inhibit production of ethylene in the cultivated food after harvesting the cultivated food; or inhibit polygalacturonase activity in the cultivated food after harvesting the cultivated food.

The method may also promote certain processes that can improve the longevity of the harvested food to increase storage and shelf life. Accordingly, the method can include applying a sufficient amount of the folate composition to: promote cell division and/or cell growth in the cultivated food after harvesting the cultivated food; promote DNA synthesis, RNA synthesis, or repair of DNA or RNA in the cultivated food after harvesting the cultivated food; and/or promote pectin synthesis in the cultivated food after harvesting the cultivated food.

In one embodiment, the method of preserving the cultivated food can include dipping the cultivated food into the preservative composition or spraying the cultivated food with the preservative composition. This can include the preservative composition being a fluid or flowable composition, such as an aqueous liquid. However, gelatinous or thickened liquids (e.g., having a hydrogel carrier) may also be used. Powdered preservative compositions may also be used for dipping or spraying. In one aspect, the cultivated food may first be subjected to a water treatment to moisten the outside surfaces, and then the preservative composition can be applied thereto.

In one embodiment, the method of preserving the cultivated food can include storing the harvested cultivated food having the preservative composition thereon. The storage can be at any temperature, at any humidity, for any duration, whether in an airtight container or package or being exposed to ambient conditions. In one example, the storage can be outdoors with temperatures that range from day temperatures to night temperatures (e.g., below 40° C.), which may vary with climate and season. In another example, the storage can be indoors at room temperature (e.g., 20° C. to 30° C.). In another example, the storage can be in a refrigerator unit (e.g., 0° C. to 20° C.). During winter in cold climates, the food may be heated during storage or transportation so as to be within the aforementioned temperature ranges.

In one embodiment, the method of preserving the cultivated food can include placing the harvested cultivated food into a container, and sealing the container containing the harvested cultivated food having the preservative composition. The container can be a rigid or flexible container with or without a re-sealable opening. The preservative composition can be applied before, during or after introducing the harvested cultivated food therein.

In one embodiment, the method of preserving the cultivated food can include providing a substrate having the preservative composition thereon, and applying the substrate to the cultivated food so that the preservative composition is applied to the cultivated food. The substrate can be in any form, from flexible to rigid. The substrate may also be part of a flexible package or rigid container, such as a wall thereof. The food may also be wrapped or encapsulated in the substrate. For example, the method can include placing the harvested cultivated food in a package that includes the substrate having the preservative composition thereon, and packaging the harvested cultivated food having the preservative composition in the package. In another example, the method can include encapsulating the harvested cultivated food in the substrate. Thus, the substrate can be used in any manner to apply the preservative composition to the cultivated food.

All experiments described herein proved that folates substances (e.g., with or without the hydrogel carrier) can be used for improving the preservation of fruits, vegetables and other perishable agricultural products. All treated fruits and vegetables showed considerable increase in shelf life at ambient temperatures when treated with the preservative composition. The preservation was enhanced even at outside temperatures between 36-40° C., and at room temperatures of 32-35° C.) with a relative humidity close to 80%. Treatment with preservative composition also showed increased shelf life of fruits and vegetables at cooler temperatures (e.g., 0° C. to 20° C.) using a commercially available refrigerator. The preservation maintained high quality harvested food without loss of its natural texture, freshness, flavor, taste and nutritional values.

The food preservation techniques described herein can be used with present day packaging materials. In one example, a polymeric food wrapper (e.g., polypropylene) can be coated with the preservative composition, and then shrink-wrapped onto the harvested food. The shrink wrapping allows the folate substance to come in contact with the harvested food.

In one embodiment, the preservative composition can be used for all fruits (e.g., climacteric and non-climacteric) and vegetables. The preservation composition can inhibit proteolytic degradation of the food by maintaining strong cell walls. As such, the preserved food can retain a suitable appearance, texture, taste, flavor, aroma, and nutritive value during storage. The preserved cell walls may also inhibit microbial infestations, such as from bacteria and fungi, in part by retaining the surface of the food in good condition so that it can naturally protect against microbes.

In one embodiment, the food preservation may be achieved with a polymeric barrier (e.g., hydrogel carrier) to prevent oxygen diffusion and moisture loss that may degrade the food. The polymeric barrier may also help maintain the cell turgor pressure in treated fruit and vegetables.

In one embodiment, the hydrogel carrier can improve the retention of the folate substance on the surface of the food as well as improve translocation of the folate substance into the food. This can inhibit the folate substance from being wiped or otherwise removed from the food.

In one example, the preservative composition can include a folate hydrogel that is folic acid with a crosslinked carboxymethyl cellulose edible polymer material. This edible polymer has moderate strength, is resistant to oils and fats, and flexible, transparent, flavorless, colorless, tasteless, water-soluble, and is a moderate barrier to oxygen. Thus, the preservative composition is useful for fruit and vegetable coating for improved preservation and storage.

In one example, the preservative composition can include a folate hydrogel, folic acid, folate, or folate derivatives. The preservative composition can provide the folate substance to promote repairing DNA damage, synthesis of nucleic acids (e.g., DNA, RNA), and methylation of DNA. The folate substance may also improve post-harvest treatment and packaging of cultivated foods by reducing the loss of moisture due to retention of cell wall structural integrity. The cell wall can be maintained by inhibiting degradation of the cell wall and its components with the folate substance.

In one embodiment, the hydrogel carrier is prepared from a cellulose derivative form that is suitable for use as an edible coating or film, such as: hydroxypropyl cellulose (HPC), hydroxypropyl methylcellulose (HPMC), carboxymethylcellulose (CMC), or methylcellulose (MC). These cellulose derivatives exhibit thermogelation; therefore when suspensions are heated they form a gel, whereas they return to original consistency when cooled. The films casted from aqueous solutions of MC, HPMC, HPC, and CMC can have moderate strength, can be resistant to oils and fats, and are flexible, transparent, flavorless, colorless, tasteless, water-soluble, and provide moderate barriers to oxygen.

Hydrogels of gelatin crosslinked with glutaraldehyde and sodium carboxymethyl cellulose (NaCMC) of several compositions were prepared. The swelling kinetics as a function of composition, temperature, pH, and ionic strength were studied. The rate of swelling and equilibrium swelling were found to depend on the NaCMC content in all cases. The equilibrium swelling increased with the temperature. The gels, which were weakly acidic, registered increased swelling at higher pH. Swelling was suppressed in aqueous salt solutions. Swelling in monovalent salt solutions was greater than in divalent salt solutions.

In one embodiment, a method of preserving a harvested cultivated food can include applying a folate composition onto a cultivated food. The folate composition can include a carrier associated with a folate substance. The carrier can be water, hydrogel, or any other carrier. The folate substance can include folic acid, folate, folate ion, folate salt, tetrahydrofolic acid, tetrahydrofolate, tetrahydrofolate ion, tetrahydrofolate salt, methyltetrahydrofolic acid, methyltetrahydrofolate, methyltetrahydrofolate ion, methyltetrahydrofolate salt, levomefolic acid, levomefolate, levomefolate ion, levomefolate salt, degradation product thereof, or combination thereof. The degradation product of the folate substance can include a pterin, para-amino benzoic acid, benzoic acid, para-amino benzoyl glutamic acid, para-amino benzoyl glutamate, ions thereof, salts thereof, or combinations thereof. The carrier of the folate composition can include a hydrogel formed from a polymer selected from the group consisting of polyethylene glycol, hydroxyethyl cellulose, hydroxypropyl cellulose, carboxymethyl cellulose, ethyl cellulose, methyl cellulose, ethylmethyl cellulose, hydroxypropyl methyl cellulose, cellulose acetate, cellulose triacetate, cellulose propionate, cellulose acetate butyrate, and combinations thereof. In one aspect, the hydrogel carrier includes hydroxypropyl cellulose, hydroxypropyl methyl cellulose, carboxymethyl cellulose, or methyl cellulose. In one aspect, folate substance is non-covalently associated with the hydrogel carrier. In another aspect, the folate substance is covalently coupled with the hydrogel carrier.

The method can include applying a sufficient amount of the folate composition to: promote cell division and/or cell growth in the cultivated food after harvesting the cultivated food; promote DNA synthesis, RNA synthesis, or repair of DNA or RNA in the cultivated food after harvesting the cultivated food; promote pectin synthesis in the cultivated food after harvesting the cultivated food; inhibit ripening of the cultivated food after harvesting the cultivated food; inhibit degradation of the cultivated food after harvesting the cultivated food; inhibit cell wall degradation in the cultivated food after harvesting the cultivated food; inhibit cellulose or hemicellulose degradation in the cultivated food after harvesting the cultivated food; inhibit formation of acetylene in the cultivated food after harvesting the cultivated food; inhibit production of ethylene in the cultivated food after harvesting the cultivated food; or inhibit polygalacturonase activity in the cultivated food after harvesting the cultivated food.

The method can include applying the folate composition prior to harvesting the cultivated food, during harvesting the cultivated food, or after harvesting the cultivated food. The applying can include dipping the cultivated food into the folate composition or spraying the cultivated food with the folate composition or coating the cultivated food with the folate composition. The method can include storing the cultivated food having the folate composition thereon. The method can include refrigerating the cultivated food having the folate composition.

In one embodiment, the method can include placing the cultivated food into a container, and sealing the container containing the cultivated food having the folate composition thereon.

In one embodiment, the method can include providing a substrate having the folate composition thereon, and applying the substrate to the cultivated food so that the folate composition is applied to the cultivated food.

In one embodiment, the method can include placing the cultivated food in a package that includes the substrate having the folate composition thereon, and packaging the cultivated food having the folate composition in the package. In one aspect, the method can include encapsulating the cultivated food in the substrate.

In one embodiment, a container for protecting harvested cultivated food can include a container having a removable lid, and a folate composition in the container. In one aspect, the folate composition is a hydrogel.

In one embodiment, a substrate for protecting harvested cultivated food can include a substrate, and a folate composition on the substrate. The substrate can be a flexible polymeric substrate, such as a plastic bag, or it can be a rigid substrate.

In one embodiment, the preservation systems and methods can be used to preserve any cultivated plant. That is, in the present disclosure, the term “food” may be replaced with “plant” in that harvested plants can have improved preservation and shelf life when treated with the preservation composition. As such, any type of harvested plant or portion thereof can have improved preservation when treated. In one example, flowers can be treated with the preservative composition to improve preservation, storage, and shelf life of the flower before wilting. In one example, a leaf can be treated with the preservative composition to improve preservation, storage, and shelf life of the leaf before wilting. As such, reference to plants herein may also refer to plant portions, such as flowers or leaves.

In one embodiment, a method of preserving a harvested cultivated plant can include applying a folate composition onto a cultivated plant. The folate composition can include a carrier associated with a folate substance. The carrier can be water or a hydrogel, or any other carrier. The folate substance can include folic acid, folate, folate ion, folate salt, tetrahydrofolic acid, tetrahydrofolate, tetrahydrofolate ion, tetrahydrofolate salt, methyltetrahydrofolic acid, methyltetrahydrofolate, methyltetrahydrofolate ion, methyltetrahydrofolate salt, levomefolic acid, levomefolate, levomefolate ion, levomefolate salt, degradation product thereof, or combination thereof. The degradation product of the folate substance can include a pterin, para-amino benzoic acid, benzoic acid, para-amino benzoyl glutamic acid, para-amino benzoyl glutamate, ions thereof, salts thereof, or combinations thereof. The carrier of the folate composition can include a hydrogel formed from a polymer selected from the group consisting of polyethylene glycol, hydroxyethyl cellulose, hydroxypropyl cellulose, carboxymethyl cellulose, ethyl cellulose, methyl cellulose, ethylmethyl cellulose, hydroxypropyl methyl cellulose, cellulose acetate, cellulose triacetate, cellulose propionate, cellulose acetate butyrate, and combinations thereof. In one aspect, the hydrogel carrier includes hydroxypropyl cellulose, hydroxypropyl methyl cellulose, carboxymethyl cellulose, or methyl cellulose. In one aspect, the folate substance is non-covalently associated with the hydrogel carrier. In one aspect, the folate substance is covalently coupled with the hydrogel carrier.

In one embodiment, the method can include applying a sufficient amount of the folate composition to: promote cell division and/or cell growth in the cultivated plant after harvesting the cultivated plant; promote DNA synthesis, RNA synthesis, or repair of DNA or RNA in the cultivated plant after harvesting the cultivated plant; promote pectin synthesis in the cultivated plant after harvesting the cultivated plant; inhibit drying or decaying of the cultivated plant after harvesting the cultivated plant; inhibit degradation of the cultivated plant after harvesting the cultivated plant; inhibit cell wall degradation in the cultivated plant after harvesting the cultivated plant; inhibit cellulose or hemicellulose degradation in the cultivated plant after harvesting the cultivated plant; inhibit formation of acetylene in the cultivated plant after harvesting the cultivated plant; inhibit production of ethylene in the cultivated plant after harvesting the cultivated plant; or inhibit polygalacturonase activity in the cultivated plant after harvesting the cultivated plant.

The method can include applying the folate composition prior to harvesting the cultivated plant, during harvesting the cultivated plant, or after harvesting the cultivated plant. The applying can include dipping the cultivated plant into the folate composition or spraying the cultivated plant with the folate composition or coating the cultivated plant with the folate composition. The method can include storing the cultivated plant having the folate composition thereon. The method can also include refrigerating the cultivated plant having the folate composition.

In one embodiment, the method can include placing the cultivated plant into a container, and sealing the container containing the cultivated plant having the folate composition thereon.

In one embodiment, the method can include providing a substrate having the folate composition thereon, and applying the substrate to the cultivated plant so that the folate composition is applied to the cultivated plant.

In one embodiment, the method can include placing the cultivated plant in a package that includes the substrate having the folate composition thereon, and packaging the cultivated plant having the folate composition in the package. The method may also include encapsulating the cultivated plant in the substrate.

### EXPERIMENTAL

Experiments were carried out on fruits, vegetables, and flowers over a duration of 3-6 weeks during which the temperature varied from 26 to 36° C., while relative humidity varied from 65% to 89%, in lab open space without any refrigeration or air conditioning.

Folate hydrogel was synthesized from folic acid crosslinked with sodium carboxymethyl cellulose in the presence of sodium hydroxide as a catalyst. The synthesis can include 5 g folic acid being dissolved in 20 mL water and 5 g sodium carboxymethyl cellulose being added with continuous stirring. Drops of NaOH solution can be added to the mixture. The mixture can be heated at about 100° C. for 10-12 minutes, where the resultant homogeneous pink/light red solution can be cooled at room temperature. The reaction solution turned into a yellow colored folate hydrogel. This synthesized material has moderate strength, is resistant to oils and fats, and is flexible, flavorless, colorless, tasteless, water-soluble, and provides a moderate barrier to oxygen.

Folate hydrogel or folic acid treated fruits, vegetables, flowers, or leaves retained considerable freshness during storage at normal room temperatures (up to 38° C. during summer) for several weeks under packed conditions. Folate hydrogel was prepared as a crosslinked polymer of folic acid and carboxymethyl cellulose. Fruits, vegetables, leaves, and flowers naturally contain folic acid, but the folic acid is drastically depleted in fruits, vegetables and leafy vegetables after harvest. When fruits, vegetables, leaves, or flowers are detached from a plant, the nutrient source is severed, and folate synthesis is stopped. This can cause DNA damage and DNA change, signaling for synthesis of enzymes and/or hormones (e.g., ethylene) responsible for ripening. Now, the folate substance in the preservative composition can act as a cofactor in the biochemical process to repair and synthesize DNA, methylate DNA, restore cell division, and improve cell growth. The folate substance can also improve synthesis of cellulose, hemicelluloses, pectin, enzymes and hormones (e.g., auxin, cytokinin, etc.) synthesis, which are useful for retention of freshness of plant parts after harvest. Therefore, folate treatment helps to prevent DNA damage, improves DNA and RNA synthesis, improves cell division, improves cell growth, and improves maintenance of new cells of the fruit skin or the inner cells.

Folate hydrogel or folic acid can be dissolved in water in a container. Harvested fresh fruits and vegetables can be dipped in 1% folate hydrogel or folic acid aqueous solution for 15-30 minutes. The treated fruits and vegetables can be air dried (e.g., in shade) for a few minutes to remove the adhered water. The treated fruits and vegetables can be packed in a polymer package (e.g., polyethylene packet) for storage and transport at normal temperature. The freshness, natural texture, crispness, aroma and taste of treated fruits and vegetables can be retained for weeks without any undesirable changes. When treated fruits and vegetables are stored at low temperatures (e.g., refrigerator) the shelf life can increase significantly.

After harvesting, fresh fruits and vegetables can be heaped and 1-5% folate hydrogel or folic acid aqueous solution can be sprayed on the fruits and/or vegetables while turning them to spray on all fruits and/or vegetables and all sides thereof. The treated fruits and vegetables can be air dried for a few minutes, and then packed in a plastic package for storage and transport at normal temperatures. If treated fruits and vegetables are stored at low temperatures (e.g., refrigerator) the shelf life can increase significantly. The folic acid concentration in the solution may vary from 1-5%. The preservative composition can be retained on the fruits and/or vegetables for 15-30 minutes or longer depending on the types and stages of ripeness of the fruits and/or vegetables and the duration to be stored after harvest.

A folate hydrogel solution or solution of folic acid may be sprayed directly on growing fruits and/or vegetables, or on the plants by mechanized spraying, or hand sprayer or through sprinkler irrigation (e.g., 1-7 days before harvesting). Treated fruits and/or vegetables can retain freshness for long time periods (e.g., weeks or months) after harvesting, during storage, transport and retailing without keeping the treated fruits and/or vegetables in a cold storage condition.

The fruits and vegetables can be treated with the preservative composition and shrink-wrapped in a package. During shrink-wrapping of fruits and vegetables, folate hydrogel or folic acid (e.g., without hydrogel) can be added to the polymeric shrink-wrapping material. The folate hydrogel or folic acid can mix with polymers before or during shrink-wrapping. The fruits and vegetables inside the polymer coating can be in direct contact with folate hydrogel or folic acid, which will preserve the fruits and vegetables for long periods of time during transport and storage.

Tomatoes were dipped in a folate hydrogel solution for 5 minutes and compared to a control of only water. The treated tomatoes retained full freshness for 20 days when stored at room temperatures without packaging, while the control tomatoes rotted and became contaminated with a fungal infection.

Guava (e.g., less ripe and more-ripe comparisons) were treated with folate hydrogel by dipping and compared to a water-only control. After 7 days, the water-only control guava were soft and had mushy spots, but the treated guava were robust and harder. The less ripe guava were in better condition than the more-ripe guava, which indicates that the folate hydrogel can inhibit ripening. After 10 days, the water-only control guava were very soft, rotten and inedible, while the treated guava was ripe and edible. The treated guava had less volatile organic compounds (VOC) compared to the water-only controls, which indicates the preservative treatment indeed preserves the guava.

Drop test experiments were performed for tomato fruits. Tomatoes became very hard and retained their freshness and hardness for months at normal humidity in subtropical temperatures when dipped in folate hydrogel or folic acid solution for a few minutes only. Whereas, water-only dipped (e.g., untreated) tomatoes gradually softened as they ripened further during storage within a week or less. Both treated and untreated packaged tomatoes were stored for a few days before conducting the drop test. During room temperature storage, the tomatoes received 2-3 hours of direct sunlight from a window pane during storage at 36° C. Two drop tests were performed with treated and untreated tomatoes. After 2 days (e.g., Test 1) and after 7 days (e.g., Test 2) post treatments, tomatoes were tested for tightness, hardness and overall freshness. During the tests, both tomatoes were dropped from 1.524 meters (5 feet) and 2.7432 meters (9 feet) heights. After dropping from both heights, treated tomatoes had no breakage, ruptures, or cracks on the skin. On the other hand, the untreated tomatoes were damaged with cracks on the skin after dropping from both heights. Drop tests have been repeated with different samples for three times. All tests showed treated tomatoes were very hard compared to the softer controls.

In view of the foregoing, folate hydrogel is shown to be a useful preservative composition for the treatment of fruits and vegetables for long distance transport. Tomatoes can be stacked to at least 100 layers one above another without any interspace layer inside the box for a long transport without any damage of the fruits.

Treatment and packaging of ripe bananas with folic acid was studied. It was determined that the folic acid dipped ripe bananas retained excellent freshness after more than 3 days at room temperature (36° C.). However, the untreated bananas were rotten within 2 days.

Additionally, bananas treated with calcium carbide, which induces ripening, were also treated with folic acid for 10 minutes by dipping. The folic acid treated bananas that had previously been treated with calcium carbide retained freshness after 4 days at normal room temperature. However, the bananas that were treated with calcium carbide but not treated with folic acid became completely rotten after 4 days.

Folic acid treatment and packaging was performed for ripe mangos. Mangos were subjected to calcium carbide for artificial ripening, and then dipped in a 1% folic acid solution or water only for a few minutes. The folic acid treated mangos retained excellent hardness and freshness after 7 days at room temperature even though the fruit was pre-treated with calcium carbide. The untreated mangos (e.g., water only) became overripe and unsuitable for consumption. It is interesting that folic acid can inhibit the action of ripening inducing chemicals like calcium carbide. This shown that folic acid may improve preservation further when there is not treatment with calcium carbide or other ripening composition. This also shows that folic acid can inhibit the action of acetylene gas, which is similar to ethylene, that can accelerate the ripening process. Thus, folic acid can inhibit the ripening action of acetylene, and likely ethylene.

Folic acid treatment and packaging of guavas was performed. The guavas were treated with folic acid as described herein, but without a ripening accelerator. After 24 hours, the folic acid treated guavas retained their full greenness due to retention of chlorophyll. The untreated guavas became yellowish due to chlorophyll degradation on the skin cells. After 2 days at 36° C. in packed conditions, folic acid treated guavas were fresh, green, hard and had no symptoms of ripening. The untreated guavas turned yellow, had a blackening of skin, and visible bruise marks. After 3 days, the untreated guavas were completely yellow and overripe; however, the folic acid treated guavas were still green in color, hard, and had no symptoms of ripening.

After 4 days, the guavas were sliced open and the insides were examined. Guava ripens very fast at 36° C. in a high humidity climatic region. Untreated guavas were ripe on the next day. The folic acid treated guavas retained their green color up to 72 hours, were hard, fleshy and just ripe to eat. However, the untreated guavas were overripe, soft, had excessive aroma and were unsuitable to eat.

It was found that folic acid treated tomatoes are fresh and hard after 4 days, but the untreated tomatoes were rotten. Both treated and untreated tomatoes were kept at 35-36° C.

Folic acid was also used for treatment of sapota (Sapodilla/Manikarazapota). Sapota fruits were harvested from the plant and treated with folic acid or dipped in water only when the fruits were still very hard. After 4 days in packing, the folic acid treated fruit was perfectly ripe with a sweet aroma and were edible. The untreated fruit was ripe on the 2nd day, and on 4th day it was overripe, very soft and released very high VOC. The fruit was also quite dry and not edible.

Folic acid treatment was performed on okra that were subsequently packaged. The okra fruits were kept packed after treatment for 10 days at room temperatures. The treated fruit retained 90% moisture, freshness, and had mucilaginous substances. The untreated okra became dry, brittle, and had no mucilaginous substance when broken. Interestingly, it was found that folic acid treatment induced cell division and cell growth on the cut end of the okra, but untreated fruit showed no such cell development.

Folic acid treatment was performed for okra that was not packaged. It is known that okra is a very soft vegetable, it becomes soft and dry within 24 hours after harvest at normal temperatures. Interestingly, it was found that the folic acid treated okra fruit retained 70% freshness when kept in open air conditions without packaging. However, the water only control resulted in okra that was very soft, easily bendable, and over ripe.

Folic acid treatment was performed on pointed gourd without packaging. After 4 days, the folic acid treated pointed gourd retained 70% color, moisture, freshness, and hardness, and where identified as being edible when stored without packaging. The untreated pointed gourds were dry, had shrunk, and had a loss of moisture when stored without packaging.

Folic acid treatment was performed for balsam flowers without packaging. Balsam flowers are very soft, and become overly dry within few hours after harvest if kept in open air (e.g., at 36° C.). Folic acid dipped flowers were determined to be 80% fresh after 24 hours. The untreated flowers were completely dry without any freshness. Thus, in addition to preserving cultivated foods after harvesting, the preservative compositions can also preserve any harvested plant or plant portion (e.g., flowers, leaves, etc.).

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method of preserving a harvested cultivated food, the method comprising:
applying a folate composition onto a cultivated food, the folate composition comprising a carrier associated with a folate substance.

2. The method of claim 1, wherein the folate substance includes folic acid, folate, folate ion, folate salt, tetrahydrofolic acid, tetrahydrofolate, tetrahydrofolate ion, tetrahydrofolate salt, methyltetrahydrofolic acid, methyltetrahydrofolate, methyltetrahydrofolate ion, methyltetrahydrofolate salt, levomefolic acid, levomefolate, levomefolate ion, levomefolate salt, degradation products thereof, or combinations thereof.

3. The method of claim 2, wherein the degradation product of the folate substance includes a pterin, para-amino benzoic acid, benzoic acid, para-amino benzoyl glutamic acid, para-amino benzoyl glutamate, ions thereof, salts thereof, or combinations thereof.

4. The method of claim 1, wherein the carrier of the folate composition includes a hydrogel formed from a polymer selected from the group consisting of polyethylene glycol, hydroxyethyl cellulose, hydroxypropyl cellulose, carboxymethyl cellulose, ethyl cellulose, methyl cellulose, ethylmethyl cellulose, hydroxypropyl methyl cellulose, cellulose acetate, cellulose triacetate, cellulose propionate, cellulose acetate butyrate, and combinations thereof.

5. The method of claim 4, wherein the hydrogel carrier includes hydroxypropyl cellulose, hydroxypropyl methyl cellulose, carboxymethyl cellulose, or methyl cellulose.

6. The method of claim 4, wherein the folate substance is non-covalently associated with the hydrogel carrier.

7. The method of claim 4, wherein the folate substance is covalently coupled with the hydrogel carrier.

8. The method of claim 1, further comprising applying a sufficient amount of the folate composition to:
promote cell division and/or cell growth in the cultivated food after harvesting the cultivated food;
promote DNA synthesis, RNA synthesis, or repair of DNA or RNA in the cultivated food after harvesting the cultivated food;
promote pectin synthesis in the cultivated food after harvesting the cultivated food;
inhibit ripening of the cultivated food after harvesting the cultivated food;
inhibit degradation of the cultivated food after harvesting the cultivated food;
inhibit cell wall degradation in the cultivated food after harvesting the cultivated food;
inhibit cellulose or hemicellulose degradation in the cultivated food after harvesting the cultivated food;
inhibit formation of acetylene in the cultivated food after harvesting the cultivated food;
inhibit production of ethylene in the cultivated food after harvesting the cultivated food; or
inhibit polygalacturonase activity in the cultivated food after harvesting the cultivated food.

9. The method of claim 1, further comprising applying the folate composition prior to harvesting the cultivated food, during harvesting the cultivated food, or after harvesting the cultivated food.

10. The method of claim 1, the applying comprising dipping the cultivated food into the folate composition, or spraying the cultivated food with the folate composition, or coating the cultivated food with the folate composition.

11. The method of claim 1, further comprising storing the cultivated food having the folate composition thereon.

12. The method of claim 11, further comprising refrigerating the cultivated food having the folate composition.

13. The method of claim 1, further comprising:
placing the cultivated food into a container; and
sealing the container containing the cultivated food having the folate composition thereon.

14. The method of claim 1, further comprising:
providing a substrate having the folate composition thereon; and
applying the substrate to the cultivated food so that the folate composition is applied to the cultivated food.

15. The method of claim 14, further comprising:
placing the cultivated food in a package that includes the substrate having the folate composition thereon; and
packaging the cultivated food having the folate composition in the package.

16. The method of claim 14, further comprising encapsulating the cultivated food in the substrate.

17. A container for protecting harvested cultivated food, the container comprising:
a container having a removable lid; and
a folate composition in the container, the folate composition comprising a hydrogel carrier associated with a folate substance.

18. The container of claim 17, wherein the folate composition is a hydrogel.

19. A substrate for protecting harvested cultivated food, the substrate comprising:
a folate composition on the substrate, the folate composition comprising a hydrogel carrier associated with a folate substance.

20. The substrate of claim 19, wherein the substrate is a flexible polymeric substrate.
